(19) United States
(12) Patent Application Publication
(10) Pub. No.: US 2006/0013925 A1
(43) Pub. Date: Jan. 19, 2006

(54) Vacuum puffed and expanded fruit

(76) Inventors: Michael N. Bauman, Battle Creek, MI (US); Pradip Roy, Grand Rapids, MI (US); Nirmal K. Sinha, Frankfort, MI (US); Meena Sinha, Frankfort, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/180,238

(22) Filed: Jul. 13, 2005

Related U.S. Application Data
(60) Provisional application No. 60/587,419, filed on Jul. 13, 2004.

(51) Int. Cl. A23B 7/16

(52) U.S. Cl. 426/102

(57) ABSTRACT

A method is disclosed for preparing an expanded, vacuum puffed, dried fruit product. The method includes infusing the fruit with a low Brix infusion solution and then expanding the fruit by subjecting it to a vacuum at elevated temperature followed by drying of the fruit under a vacuum at elevated temperature and finally cooling of the fruit under lowered temperature while maintaining the vacuum. The product produced by the method is light, crisp, and has a low water activity and a low buoyant density.

### RELATED APPLICATIONS

The present application claims the benefit of U.S. provisional application No. 60/587,419, filed on Jul. 13, 2004.

### STATEMENT REGARDING FEDERALLY SPONSORED RESEARCH

None.

### TECHNICAL FIELD

This invention relates generally to expanded fruit or fruit pieces and, more particularly, to a method of expanding fruit comprising providing a low infused fruit and subjecting it to expansion under vacuum to provide a stable, expanded fruit and to the products produced by the method.

### BACKGROUND OF THE INVENTION

Consumers enjoy fruit and have been encouraged to enjoy more fruits in their diets. Fresh fruit is readily available; however, it cannot be used in many shelf stable products like ready-to-eat cereals and snack foods. In the past shelf stable fruit products have been in the form of either dried fruits, fruit leathers, or fruit beverages.

Consumers do not always find dried fruits to be appealing due to their taste, texture, and appearance. Use of current dried fruits in ready-to-eat cereals is problematic because of their undesirable characteristics described above and also because they are very dense. The high density of current dried fruits causes them to sink to the bottom of the bowl in ready-to-eat cereal products and consumers find this unacceptable.

Consumers desire a light, crisp, good tasting dried fruit that retains as much of its original shape as possible. Consumers would also prefer a dried fruit that floats in the liquid portion of a bowl of ready-to-eat cereal.

In the past attempts have been made to use freeze drying to form fruit pieces for consumers to enjoy. A typical freeze drying process begins by freezing the fruit to a temperature below its eutectic point, for example, for blueberries this is approximately −7° C. The frozen fruit is then loaded into the freeze dryer and a vacuum is pulled in the micron range of pressure. During a first freeze drying stage of approximately 12 hours the food is kept at a temperature below its eutectic point to prevent collapse of the food structure. The time period is until essentially all of the free water in the fruit has been removed. This stage is over when the vapor pressure drops in the freeze dryer indicating that no more free water remains. Then a second stage of freeze drying is commenced wherein the vacuum is kept in the micron range but the temperature is increased to as high as 80° C. The second stage is maintained until the desired final moisture of 2 to 3% is achieved. The problems with this process include the long time to dry the product, the poor texture of the product, the general lack of taste in the product and poor consumer acceptance.

Other attempts have been made to use vacuum drying to produce an acceptable product. These have generally failed due to collapse of the food structure, poor taste, and poor consumer acceptance. In a typical vacuum drying process a submarine chamber is used with airlocks to create a continuous process. The chamber includes a series of conveyor belts with platens set at different temperatures to heat the food as it moves through the system. The entire system is under a uniform vacuum through out the entire process. The food is loaded onto the first belt, which is generally at a temperature of 100° C., and progressively heated to higher temperatures.

### SUMMARY OF THE INVENTION

In general terms, this invention provides a dried expanded fruit product that has a light, crisp taste and a low buoyant density allowing it to float in a bowl of ready-to-eat cereal containing milk. Basic steps of the method comprise taking whole fruit or fruit pieces and infusing it with a low Brix infusion solution having a Brix of from 15 to 60. Following infusion the infused fruit is either frozen or immediately taken to a vacuum dryer. Once in the vacuum dryer the fruit, either frozen or fresh infused, is equilibrated at atmospheric pressure for a first period of time. After the first period of time the fruit is expanded and puffed at a second temperature under a vacuum of 100 to 5 millibars of pressure. After the fruit has expanded and puffed it is dried for several periods of time at selected temperatures while maintaining the vacuum at 10 to 5 millibars of pressure. Once the expanded and puffed fruit has been dried it is cooled while maintaining the vacuum at 10 to 5 millibars of pressure for a desired period of time. The final product is a dried, expanded fruit product that maintains much of its initial shape and appearance. The fruit is light, crisp, and has a buoyant density that allows it to float in the liquid portion of a bowl of ready-to-eat cereal.

In a first embodiment, the present invention is a method of forming a vacuum puffed and expanded fruit comprising the steps of: providing an infused fruit; placing the infused fruit in a vacuum dryer and equilibrating it at a temperature of from 25 to 90° C. for a period of time of from 4 to 15 minutes at atmospheric pressure; expanding and puffing the infused fruit at a temperature of from 25 to 92° C. of a period of time of from 10 to 80 minutes under a vacuum of from 100 to 5 millibars; drying of the fruit under a vacuum of from 10 to 5 millibars and a temperature of from 70 to 95° C. for a period of time of from 50 to 280 minutes; and cooling the dried, expanded infused fruit under a vacuum of from 10 to 5 millibars at a temperature of from 15 to 25° C. for a period of time of from 10 to 30 minutes.

In another embodiment, the present invention comprises a vacuum puffed and dried infused fruit having a water activity level of from 0.1 to 0.35 and a bulk density of from 0.08 to 0.30.

These and other features and advantages of this invention will become more apparent to those skilled in the art from the detailed description of a preferred embodiment. The drawings that accompany the detailed description are described below.

### BRIEF DESCRIPTION OF THE DRAWINGS

FIG. 1 is a flow chart of the steps of infusing fruit or fruit pieces according to the present invention; and

FIG. 2 is a flow chart of one embodiment of drying the infused fruit under vacuum according to the present invention.

### DETAILED DESCRIPTION OF A PREFERRED EMBODIMENT

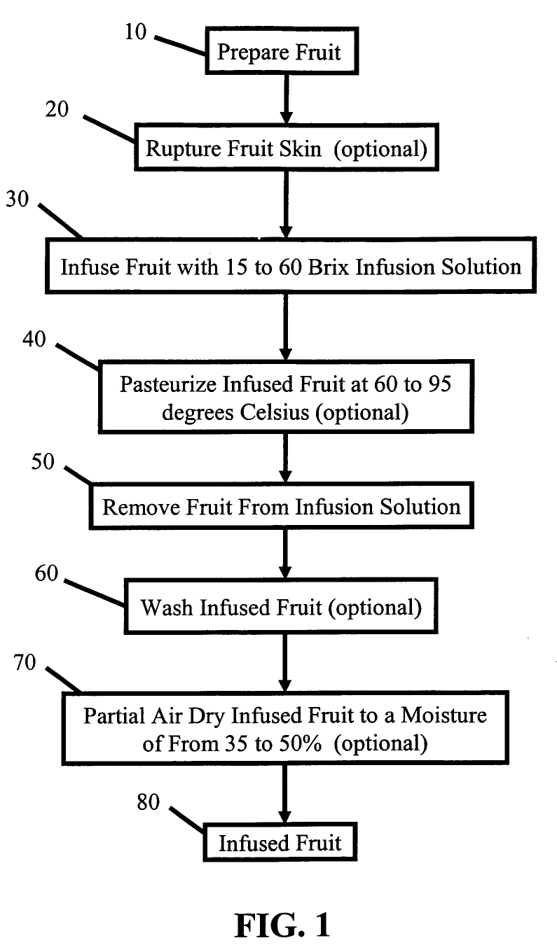

FIG. 1 is a flow chart of the steps of infusing a fruit or fruit pieces according to the present invention. In step 10 the fruit is prepared prior to the infusion. This generally comprises washing of the fruit and appropriate sizing of the fruit. For example, large fruits such as apples and peaches may need to be sized by being cut or diced prior to the infusion process. Smaller fruit such as blueberries, strawberries, cherries and other small fruits may only require a washing step. In the present specification and claims the term fruit is intended to include either the whole fruit or pieces thereof. For example, as described above larger fruits such as apples, peaches and large strawberries may be cut or diced prior to the infusion step. In optional step 20 the skin of the fruit may be ruptured. Certain fruits such as blueberries and cranberries can benefit from scarification to better allow for infusion of the infusion solution into the fruit. As indicated, this step is optional. In step 30 the prepared fruit is infused with a low Brix infusion solution having a Brix of from 15 to 60, more preferably from 15 to 40 Brix. This infusion solution preferably comprises sucrose and may optionally include high fructose corn syrup. As would be understood by one of ordinary skill in the art, however, other sweetening agents can be utilized to prepare the infusion solution. Examples of other sweeteners include glucose, fructose, dextrose, maltdextrin of DE 5 to 40, tagatose, maltose, sorbitol, invert syrup, high fructose corn syrups, molasses, corn syrup of 42 DE, and fruit juice concentrates Preferably the infusion solution includes at least one disaccharide. In addition, the infusion solution preferably includes a food grade acid such as malic acid, tartaric acid, quinic acid, ascorbic acid, citric acid, or other common food acidulants. Preferably the acid is present at a level of from 0.1 to 0.5% by weight based on the weight of the fruit. The infusion solution optionally also includes calcium chloride at a level of from 0.1 to 0.5% by weight based on the weight of the fruit. Artificial sweeteners can also be used in the infusion solution if desired. Additionally, humectants such as glycerol or sorbitol can also be used in the infusion syrup to change the fruit texture. Soluble fiber can also be added to the syrup such as inulin. The infusion can be carried out at temperatures of from 20 to 65° C., preferably at an elevated temperature of from 30 to 50° C. for anywhere from 30 minutes to 45 hours, more preferably from 30 minutes to 10 hours. The amount of fruit to infusion solution can also vary. Preferably they are in a weight ratio of from 1:1 to 1:2 in terms of fruit to infusion solution. Once the infusion has been completed an optional step is shown as step 40 in FIG. 1. The infused fruit can optionally be pasteurized at a temperature of from 60 to 95° C. In step 50 the infused fruit is removed from the infusion solution and in step 60 it is optionally washed to remove infusion solution. In step 70 an additional optional step is shown of partially air drying the infused fruit to a final moisture of from 35 to 50% by weight. Some fruits benefit from this partial drying and others do not require it. As shown in step 80 the net result is the infused fruit. FIG. 1 assumes the starting fruit is a fresh fruit. The method can also be used on pre-infused fruits like Mandarin oranges or canned pineapples as described in the examples below.

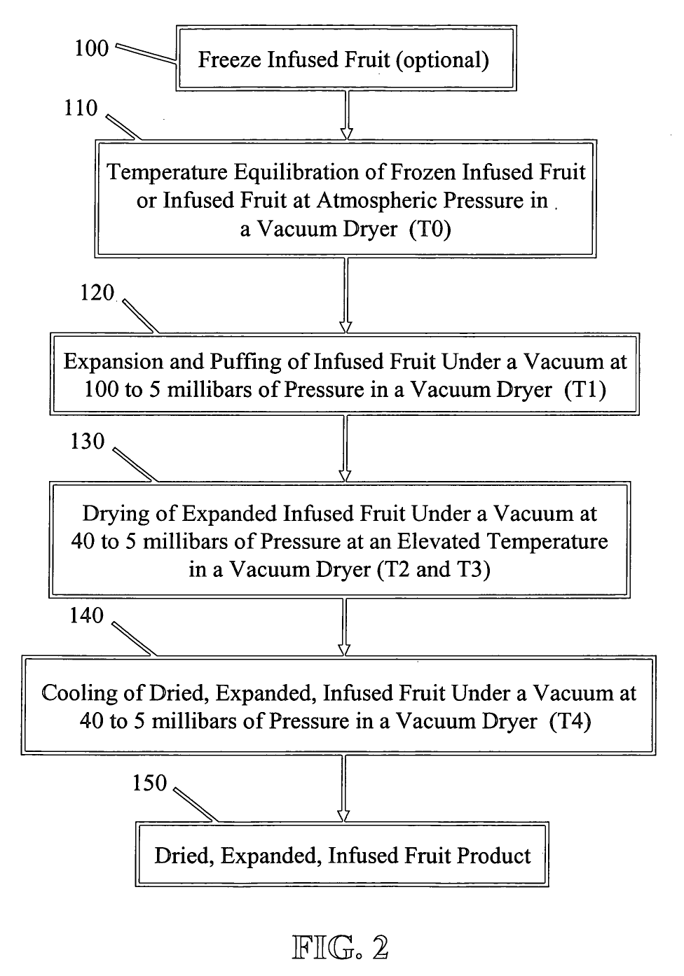

As shown in FIG. 2 step 100 the infused fruit can optionally be frozen for a period of from 1 hour to several days. The infused or frozen infused fruit is then placed in the vacuum dryer and stage 1 is begun in step 110. Stage 1 (T0) of the vacuum drying process is used to equilibrate the temperature of the infused fruit and is carried out at atmospheric pressure. Preferably the temperature during stage 1 of the drying process is from 25 to 90° C. and stage 1 is carried out for a period of time of from 4 to 15 minutes. Following stage 1 as shown in step 120 the fruit is expanded and puffed under a vacuum (T1). The vacuum varies from 100 to 5 millibars. The expansion and puffing of the infused fruit is carried out at a temperature of from 25 to 92° C. for period of time of from 10 to 80 minutes. As shown in step 130 once the fruit has been expanded and puffed the vacuum is maintained at approximately 40 to 5 millibars and the fruit is dried at an elevated temperature. Preferably stages 3 and 4 (T2 and T3) are each carried out at a temperature of from 70 to 95° C. for periods of time ranging of from 50 to 140 minutes. Following the drying stage 5 the fruit is maintained under vacuum and at a temperature of approximately 15 to 25° C. During this cooling period (T4) the vacuum is maintained at 40 to 5 millibars of pressure and the cooling duration is preferably from 10 to 30 minutes. As shown in step 150 the dried expanded and infused fruit product is then released from the vacuum and available for use. Preferably the dried, expanded, infused fruit product has a water activity level of from 0.1 to 0.35, and more preferably from 0.2 to 0.3. Preferably the final expanded dried fruit product has a bulk density of from 0.08 to 0.3, thus it will easily float in a liquid such as the milk typically used in a ready to eat cereal. The expanded and puffed fruit retains its natural shape and typical color, which consumer will find appealing. It also has a crisp texture.

### EXAMPLE 1

In a first example according to the present invention the initial fruit was whole individually quick frozen (IQF) cultivated blueberries (Vaccinium corybosum). The target Brix of the infusion syrup was about 35 Brix and the actual Brix was 34.8. The infusion syrup comprised: 0.84 pounds of sugar; 1.64 pounds of high fructose corn syrup; 0.00225 pounds of malic acid; 0.015 pounds of calcium chloride; and 3.52 pounds of water. The IQF cultivated blueberries were infused at a weight ratio of fruit to infusion syrup of 1:2. The infusion syrup was initially heated to 71° C., the fruit was added, and then the fruit and syrup were maintained at approximately 65° C. for 5 minutes and then cooled to 20 to 25° C. and held there for the remainder of the infusion time. The target final fruit Brix was about 18 to 22 Brix. The infusion was carried out for 16 hours. The final fruit Brix was 19.6. The infused fruit was then placed in the vacuum dryer. The fruit was pre-heated in stage 1 to 35° C. for 10 minutes at atmospheric pressure. In stage 2 the vacuum was turned on and the fruit was expanded and puffed at 25° C. for 15 minutes. The vacuum achieved was approximately 10 millibars. In stage 3 the vacuum was maintained and the temperature was moved up to 70° C. for 120 minutes to dry the expanded and puffed fruit. In stage 4, the vacuum was maintained and the temperature was moved up to 80° C. for 135 minutes to further dry the expanded and puffed fruit. In stage 5 the vacuum was maintained and the temperature was dropped to 20° C. for 20 minutes to cool and set the expanded and puffed fruit. It was found that if the vacuum was not maintained the expanded and puffed fruit would collapse. The final expanded, puffed, and dried fruit had a bulk density of 0.097 and a water activity of 0.226.

### EXAMPLE 2

In another example according to the present invention the initial fruit was whole individually quick frozen (IQF) cultivated blueberries. The target Brix of the infusion syrup was about 35 Brix and the actual Brix was 35.6. The infusion syrup comprised: 4.2 pounds of sugar; 0.0045 pounds of malic acid; 0.03 pounds of calcium chloride; and 7.8 pounds of water. The IQF cultivated blueberries were infused at a weight ratio of fruit to infusion syrup of 1:2. The infusion syrup was initially heated to 65° C., the fruit was added, and then the fruit and syrup were maintained at approximately 65° C. for 5 minutes and then colled to 20 to 25° C. and held there for the remainder of the infusion. The target final fruit Brix was about 18 to 22 Brix. The infusion was carried out for 41 hours. The final fruit Brix was 23.2. The fruit was partially dried at 76° C. for 1.5 hours at atmospheric pressure. The partially dried infused fruit was then placed in the vacuum dryer. The fruit was pre-heated in stage 1 to 35° C. for 10 minutes at atmospheric pressure. In stage 2 the vacuum was turned on and the fruit was expanded and puffed at 25° C. for 15 minutes. The vacuum achieved was approximately 40 millibars. In stage 3 the vacuum was maintained and the temperature was moved up to 90° C. for 70 minutes to dry the expanded and puffed fruit. In stage 4, the vacuum and temperature were maintained for an additional 50 minutes to further dry the expanded and puffed fruit. In stage 5 the vacuum was maintained and the temperature was dropped to 20° C. for 20 minutes to cool and set the expanded and puffed fruit. It was found that if the vacuum was not maintained the expanded and puffed fruit would collapse. The final expanded, puffed, and dried fruit had a bulk density of 0.185 and a water activity of 0.213.

### EXAMPLE 3

In another example according to the present invention the initial fruit was whole individually quick frozen (IQF) cultivated blueberries. The target Brix of the infusion syrup was about 35 Brix and the actual Brix was 35.8. The infusion syrup comprised: 1.8 pounds of sugar; 2.3 pounds of high fructose corn syrup; 0.004 pounds of malic acid; 0.025 pounds of calcium chloride; and 5.9 pounds of water. The IQF cultivated blueberries were infused at a weight ratio of fruit to infusion syrup of 1:1.43. The infusion syrup was initially heated to 65° C., the fruit was added, and then the fruit and syrup were maintained at approximately 43° C. The target final fruit Brix was about 20 to 25 Brix. The infusion was carried out for 16.5 hours. The final fruit Brix was 20.8. The fruit was partially dried at 74° C. for 2 hours at atmospheric pressure. The partially dried infused fruit was then placed in the vacuum dryer. The fruit was pre-heated in stage 1 to 35° C. for 10 minutes at atmospheric pressure. In stage 2 the vacuum was turned on and the fruit was expanded and puffed at 25° C. for 15 minutes. The vacuum achieved was approximately 10 millibars. In stage 3 the vacuum was maintained and the temperature was moved up to 70° C. for 135 minutes to dry the expanded and puffed fruit. In stage 4, the vacuum was maintained and the temperature moved up to 80° C. for an additional 120 minutes to further dry the expanded and puffed fruit. In stage 5 the vacuum was maintained and the temperature was dropped to 20° C. for 20 minutes to cool and set the expanded and puffed fruit. It was found that if the vacuum was not maintained the expanded and puffed fruit would collapse. The final expanded, puffed, and dried fruit had a bulk density of 0.249.

### EXAMPLE 4

In another example pre-canned Mandarin oranges in syrup were used. Because these were already in a syrup having a Brix of 15.9, the fruit was not further infused and was taken directly to the vacuum dryer. The fruit was pre-heated in stage 1 to 30° C. for 15 minutes at atmospheric pressure. In stage 2 the vacuum was turned on and the fruit was expanded and puffed at 25° C. for 10 minutes. The vacuum achieved was approximately 10 millibars. In stage 3 the vacuum was maintained and the temperature was moved up to 95° C. for 120 minutes to dry the expanded and puffed fruit. In stage 4, the vacuum and temperature were maintained for an additional 120 minutes to further dry the expanded and puffed fruit. In stage 5 the vacuum was maintained and the temperature was dropped to 20° C. for 20 minutes to cool and set the expanded and puffed fruit. It was found that if the vacuum was not maintained the expanded and puffed fruit would collapse. The final expanded, puffed, and dried fruit had a bulk density of 0.111 and a water activity of 0.310.

### EXAMPLE 5

In another example IQF strawberries were used. The first sample was whole strawberries, the second sample was ½ inch sliced strawberries, and the third sample was chopped strawberries. The first infusion syrup comprised: 0.8 pounds of sugar; 0.0025 pounds of citric acid; 0.0025 pounds of ascorbic acid; and 1.2 pounds of water. The second infusion syrup comprised: 2.9 pounds of sugar; 4.6 pounds of water; and 0.5 pounds of cranberry juice concentrate. The third infusion syrup comprised: 2.9 pounds of sugar; 4.6 pounds of water; and 0.5 pounds of cranberry juice concentrate. The samples were all infused at a fruit to syrup ratio of 1:2. The first sample was infused for 1.5 hours and the others were infused for 2 hours the infusion temperature was 30° C. The first fruit was pre-heated in stage 1 to 25° C. for 10 minutes at atmospheric pressure. In stage 2 the vacuum was turned on and the fruit was expanded and puffed at 25° C. for 10 minutes. The vacuum achieved was approximately 10 millibars. In stage 3 the vacuum was maintained and the temperature was moved to 95° C. for 120 minutes to dry the expanded and puffed fruit. In stage 4, the vacuum and temperature were maintained for an additional 120 minutes to further dry the expanded and puffed fruit. In stage 5 the vacuum was maintained and the temperature was dropped to 20° C. for 30 minutes to cool and set the expanded and puffed fruit. It was found that if the vacuum was not maintained the expanded and puffed fruit would collapse. The final expanded, puffed, and dried fruit from the first infusion syrup had a water activity of 0.306. The second and third fruit samples were pre-heated in stage 1 to 90° C. for 4 minutes at atmospheric pressure. In stage 2 the vacuum was turned on and the fruit was expanded and puffed at 91° C. for 30 minutes. The vacuum achieved was approximately 10 millibars. In stage 3 the vacuum was maintained and the temperature was moved to 90° C. for 120 minutes to dry the expanded and puffed fruit. In stage 4, the vacuum was maintained and the temperature was moved to 80° C. for an additional 100 minutes to further dry the expanded and puffed fruit. In stage 5 the vacuum was maintained and the temperature was dropped to 20° C. for 20 minutes to cool and set the expanded and puffed fruit. It was found that if the vacuum was not maintained the expanded and puffed fruit would collapse. The final expanded, puffed, and dried fruit from the second infusion syrup had a water activity of 0.221 and a bulk density of 0.080. The final expanded, puffed, and dried fruit from the third infusion syrup had a water activity of 0.250 and a bulk density of 0.106.

### EXAMPLE 6

In another example sliced apples were infused for 1 hour at 32° C. The Brix of the infusion solution was 40 and it comprised: sucrose solution containing 0.5% by weight ascorbic acid and 0.2% by weight citric acid. The ascorbic acid is use to prevent oxidative browning of the fruit. The infused fruit was infused to a Brix of 19 and then expanded and vacuum dried as described below. The infused fruit was pre-heated in stage 1 to 80° C. for 10 minutes at atmospheric pressure. In stage 2 the vacuum was turned on and the fruit was expanded and puffed at 80° C. for 15 minutes. The vacuum achieved was approximately 10 millibars. In stage 3 the vacuum was maintained and the temperature was increased to 90° C. for 100 minutes to dry the expanded and puffed fruit. In stage 4, the vacuum was maintained and the temperature was dropped to 80° C. for an additional 100 minutes to further dry the expanded and puffed fruit. In stage 5 the vacuum was maintained and the temperature was dropped to 20° C. for 20 minutes to cool and set the expanded and puffed fruit. The final product had a water activity level of 0.25±0.02.

### EXAMPLE 7

In another example canned Mandarin orange segments were used without infusion since they come prepared in syrup. Their initial Brix level was 14.8. The pre-infused fruit was pre-heated in stage 1 to 80° C. for 10 minutes at atmospheric pressure. In stage 2 the vacuum was turned on and the fruit was expanded and puffed at 80° C. for 15 minutes. The vacuum achieved was approximately 10 millibars. In stage 3 the vacuum was maintained and the temperature was increased to 90° C. for 120 minutes to dry the expanded and puffed fruit. In stage 4, the vacuum and temperature were maintained for an additional 120 minutes to further dry the expanded and puffed fruit. In stage 5 the vacuum was maintained and the temperature was dropped to 20° C. for 20 minutes to cool and set the expanded and puffed fruit. The final product had a water activity level of 0.26±0.02.

### EXAMPLE 8

In another example sliced peaches were infused in a solution comprising 90% by weight sucrose, 10% by weight High Fructose (55% fructose) Corn Syrup, 0.5% by weight ascorbic acid and 0.2% by weight citric acid. The infusion was for 30 minutes at 49° C. and the infused Brix was 20.4. The infused fruit was pre-heated in stage 1 to 80° C. for 10 minutes at atmospheric pressure. In stage 2 the vacuum was turned on and the fruit was expanded and puffed at 80° C. for 15 minutes. The vacuum achieved was approximately 20 millibars. In stage 3 the vacuum was maintained and the temperature was increased to 90° C. for 90 minutes to dry the expanded and puffed fruit. In stage 4, the vacuum was maintained and the temperature was dropped to 80° C. for an additional 100 minutes to further dry the expanded and puffed fruit. In stage 5 the vacuum was maintained and the temperature was dropped to 20° C. for 20 minutes to cool and set the expanded and puffed fruit. The final product had a water activity level of 0.32±0.02.

### EXAMPLE 9

In another example 1 pound of sliced mango was infused with a sucrose solution containing 1.5 pounds of water, 0.5 pounds of sugar, 0.005 pounds of ascorbic acid, and 0.003 pounds of citric acid for 1 hour at 38° C. The infusion Brix was 25 and the fruit was infused to a Brix of 16. The infused fruit was pre-heated in stage 1 to 80° C. for 10 minutes at atmospheric pressure. In stage 2 the vacuum was turned on and the fruit was expanded and puffed at 80° C. for 15 minutes. The vacuum achieved was approximately 10 millibars. In stage 3 the vacuum was maintained and the temperature was increased to 90° C. for 100 minutes to dry the expanded and puffed fruit. In stage 4, the vacuum was maintained and the temperature was dropped to 80° C. for an additional 110 minutes to further dry the expanded and puffed fruit. In stage 5 the vacuum was maintained and the temperature was dropped to 20° C. for 20 minutes to cool and set the expanded and puffed fruit. The final product had a water activity level of 0.25±0.02.

### EXAMPLE 10

In another example 1 pound of sliced strawberries was infused with a sucrose solution containing 1.2 pounds of water, 0.8 pounds of sugar, 0.025 pounds of ascorbic acid, and 0.025 pounds of citric acid for 6 hours at 38° C. The infused fruit Brix was 22. The infused fruit was pre-heated in stage 1 to 90° C. for 5 minutes at atmospheric pressure. In stage 2 the vacuum was turned on and the fruit was expanded and puffed at 90° C. for 30 minutes. The vacuum achieved was approximately 10 millibars. In stage 3 the vacuum and temperature were maintained for another 120 minutes to dry the expanded and puffed fruit. In stage 4, the vacuum was maintained and the temperature was dropped to 80° C. for an additional 100 minutes to further dry the expanded and puffed fruit. In stage 5 the vacuum was maintained and the temperature was dropped to 20° C. for 20 minutes to cool and set the expanded and puffed fruit. The final product had a water activity level of 0.26±0.02.

### EXAMPLE 11

In another example 5 pounds of diced canned pineapple was infused with a sucrose solution containing 4.5 pounds of water, 3.0 pounds of sugar, 0.025 pounds of ascorbic acid, and 0.015 pounds of citric acid for 1 hour and 20 minutes at 90° F. The Brix of the infused fruit was 24. The infused fruit was pre-heated in stage 1 to 50° C. for 5 minutes at atmospheric pressure. In stage 2 the vacuum was turned on and the fruit was expanded and puffed at 90° C. for 70 minutes. The vacuum achieved was approximately 10 millibars. In stage 3 the vacuum and temperature were maintained for 70 minutes to dry the expanded and puffed fruit. In stage 4, the vacuum and temperature were maintained for an additional 70 minutes to further dry the expanded and puffed fruit. In stage 5 the vacuum was maintained and the temperature was dropped to 20° C. for 20 minutes to cool and set the expanded and puffed fruit. The final product had a water activity level of 0.32.

### EXAMPLE 12

In another example fibrous cultivated blueberries (Vaccinium ashei), also known as rabbiteye blueberries, were infused with a solution of 60% by weight High Fructose Corn Syrup, 40% by weight sucrose, and 0.1% by weight malic acid having a Brix of 40 for 1 hour at 65° C. at a ratio of 1 pound of blueberries per 2 pounds of infusion solution. After infusion the product was frozen and maintained frozen overnight. The infused fruit Brix was 25.4. The frozen infused blueberries were then treated as described below. The infused fruit was held in stage 1 at 25° C. at atmospheric pressure for 10 minutes. At this stage the blueberries still had a partially iced core. In stage 2 the vacuum was turned on and the fruit was expanded and puffed at 25° C. for 10 minutes. The vacuum achieved was approximately 10 millibars. In stage 3 the vacuum was maintained and the temperature was increased to 80° C. for 120 minutes to dry the expanded and puffed fruit. In stage 4, the vacuum was maintained and the temperature was increased to 95° C. for an additional 120 minutes to further dry the expanded and puffed fruit. In stage 5 the vacuum was maintained and the temperature was dropped to 20° C. for 20 minutes to cool and set the expanded and puffed fruit. The final product had a water activity level of 0.26.

### EXAMPLE 13

In another example according to the present invention the initial fruit was whole individually quick frozen (IQF) wild blueberries (Vaccinium augustifolium). The target Brix of the infusion syrup was about 35 Brix and the actual Brix was 34.8. The infusion syrup comprised: 0.84 pounds of sugar; 1.64 pounds of high fructose corn syrup; 0.00225 pounds of malic acid; 0.015 pounds of calcium chloride; and 3.52 pounds of water. The IQF cultivated blueberries were infused at a weight ratio of fruit to infusion syrup of 1:2. The infusion syrup was initially heated to 71° C., the fruit was added, and then the fruit and syrup were maintained at approximately 65° C. for 5 minutes and then cooled to 20 to 25° C. and held there for the remainder of the infusion time. The target final fruit Brix was about 18 to 22 Brix. The infusion was carried out for 16 hours. The final fruit Brix was 19.6. The infused fruit was then placed in the vacuum dryer. The fruit was pre-heated in stage 1 to 35° C. for 10 minutes at atmospheric pressure. In stage 2 the vacuum was turned on and the fruit was expanded and puffed at 25° C. for 15 minutes. The vacuum achieved was approximately 10 millibars. In stage 3 the vacuum was maintained and the temperature was moved up to 70° C. for 120 minutes to dry the expanded and puffed fruit. In stage 4, the vacuum was maintained and the temperature was moved up to 80° C. for 135 minutes to further dry the expanded and puffed fruit. In stage 5 the vacuum was maintained and the temperature was dropped to 20° C. for 20 minutes to cool and set the expanded and puffed fruit. It was found that if the vacuum was not maintained the expanded and puffed fruit would collapse. The final expanded, puffed, and dried fruit had a bulk density of 0.097 and a water activity of 0.226.

### EXAMPLE 14

In another example according to the present invention the initial fruit was whole individually quick frozen (IQF) fibrous cultivated blueberries (Vaccinium ashei). The target Brix of the infusion syrup was about 35 Brix and the actual Brix was 34.8. The infusion syrup comprised: 0.84 pounds of sugar; 1.64 pounds of high fructose corn syrup; 0.00225 pounds of malic acid; 0.015 pounds of calcium chloride; and 3.52 pounds of water. The IQF cultivated blueberries were infused at a weight ratio of fruit to infusion syrup of 1:2. The infusion syrup was initially heated to 71° C., the fruit was added, and then the fruit and syrup were maintained at approximately 65° C. for 5 minutes and then cooled to 20 to 25° C. and held there for the remainder of the infusion time. The target final fruit Brix was about 18 to 22 Brix. The infusion was carried out for 16 hours. The final fruit Brix was 19.6. The infused fruit was then placed in the vacuum dryer. The fruit was pre-heated in stage 1 to 35° C. for 10 minutes at atmospheric pressure. In stage 2 the vacuum was turned on and the fruit was expanded and puffed at 25° C. for 15 minutes. The vacuum achieved was approximately 10 millibars. In stage 3 the vacuum was maintained and the temperature was moved up to 70° C. for 120 minutes to dry the expanded and puffed fruit. In stage 4, the vacuum was maintained and the temperature was moved up to 80° C. for 135 minutes to further dry the expanded and puffed fruit. In stage 5 the vacuum was maintained and the temperature was dropped to 20° C. for 20 minutes to cool and set the expanded and puffed fruit. It was found that if the vacuum was not maintained the expanded and puffed fruit would collapse. The final expanded, puffed, and dried fruit had a bulk density of 0.097 and a water activity of 0.226.

### EXAMPLE 15

In another example according to the present invention the initial fruit was whole individually quick frozen (IQF) cultivated blueberries (Vaccinium corybosum). The blueberries were scarified using a scarifier gap of 0.25 inches prior to infusion. The target Brix of the infusion syrup was about 55 Brix. The infusion syrup comprised: 4.28 pounds of high fructose corn syrup; 0.01 pounds of malic acid; and 1.72 pounds of water. The IQF cultivated blueberries were infused at a weight ratio of fruit to infusion syrup of 1:3. The infusion syrup was initially heated to 50° C., the fruit was added, and then the fruit and syrup were maintained at approximately 40° C. for the infusion time. The target final fruit Brix was about 27 Brix. The infusion was carried out for 8 hours. The final fruit Brix was 19.6. The infused fruit was then placed in the vacuum dryer. The fruit was pre-heated in stage 1 to 35° C. for 10 minutes at atmospheric pressure. In stage 2 the vacuum was turned on and the fruit was expanded and puffed at 25° C. for 15 minutes. The vacuum achieved was approximately 10 millibars. In stage 3 the vacuum was maintained and the temperature was moved up to 70° C. for 120 minutes to dry the expanded and puffed fruit. In stage 4, the vacuum was maintained and the temperature was moved up to 80° C. for 135 minutes to further dry the expanded and puffed fruit. In stage 5 the vacuum was maintained and the temperature was dropped to 20° C. for 20 minutes to cool and set the expanded and puffed fruit. It was found that if the vacuum was not maintained the expanded and puffed fruit would collapse. The final expanded, puffed, and dried fruit had a bulk density of 0.2 and a water activity of 0.27.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

We claim:

1. A method of forming a vacuum puffed and expanded fruit comprising the steps of:
a) providing an infused fruit;
b) placing the infused fruit in a vacuum dryer and equilibrating it at a temperature of from 25 to 90° C. for a period of time of from 4 to 15 minutes at atmospheric pressure;
c) expanding and puffing the infused fruit at a temperature of from 25 to 92° C. of a period of time of from 10 to 80 minutes under a vacuum of from 100 to 5 millibars;
d) drying of the fruit under a vacuum of from 40 to 5 millibars and a temperature of from 70 to 95° C. for a period of time of from 50 to 280 minutes; and
e) cooling the dried, expanded infused fruit under a vacuum of from 40 to 5 millibars at a temperature of from 15 to 25° C. for a period of time of from 10 to 30 minutes.

2. The method according to claim 1 wherein step a) further comprises infusing the fruit in an infusion solution comprising a sweetener and having a Brix of from 15 to 60 to form the infused fruit.

3. The method according to claim 2 wherein step a) further comprises infusing the fruit in an infusion solution comprising a sweetener and having a Brix of from 15 to 40 to form the infused fruit.

4. The method according to claim 2 wherein step a) further comprises infusing the fruit in an infusion solution at a weight ratio of fruit to infusion solution of from 1:1 to 1:3 to form the infused fruit.

5. The method according to claim 2 wherein step a) further comprises infusing the fruit in an infusion solution further comprising a food grade acid, calcium chloride, or a mixture thereof to form the infused fruit.

6. The method according to claim 5 wherein the food grade acid, calcium chloride or both are present in an amount of from 0.1 to 0.5% by weight based on the total weight of the fruit.

7. The method according to claim 5 wherein the food grade acid is selected from the group consisting of malic acid, tartaric acid, quinic acid, ascorbic acid, and citric acid.

8. The method according to claim 2 wherein the infusion is carried out for a period of time of from 30 minutes to 45 hours.

9. The method according to claim 8 wherein the infusion is carried out for a period of time of from 30 minutes to 10 hours.

10. The method according to claim 2 wherein the infusion is carried out at a temperature of from 20 to 65° C.

11. The method according to claim 1 wherein step a) comprises providing an infused fruit comprising an apple, a peach, a pear, a plum, an apricot, a nectarine, an orange, a grapefruit, a blueberry, a strawberry, a cranberry, a cherry, a melon, a mango, a pineapple, a grape or a mixture thereof.

12. The method according to claim 1 further comprising between steps a) and b) the further step of pasteurizing the infused fruit at a temperature of from 60 to 95° C.

13. The method according to claim 1 further comprising between steps a) and b) the further step of partially drying the infused fruit to a moisture content of from 35 to 50%.

14. The method according to claim 1 further comprising between steps a) and b) the further step of freezing the infused fruit.

15. A vacuum puffed and dried infused fruit having a water activity level of from 0.1 to 0.35 and a bulk density of from 0.08 to 0.30.

16. A vacuum puffed and dried infused fruit according to claim 15 having a water activity level of from 0.2 to 0.3.

17. A vacuum puffed and dried infused fruit according to claim 15 comprising an apple, a peach, a pear, a plum, an apricot, a nectarine, an orange, a grapefruit, a blueberry, a strawberry, a cranberry, a cherry, a melon, a mango, a pineapple, a grape or a mixture thereof.
